(19) United States
(12) Patent Application Publication
(10) Pub. No.: US 2010/0326678 A1
(43) Pub. Date: Dec. 30, 2010

(54) Fire protection device

(76) Inventors: Thomas Monden, Stetten (DE); Ulf Mordau, Waal (DE)

Correspondence Address: ABELMAN, FRAYNE & SCHWAB, 666 THIRD AVENUE, 10TH FLOOR, NEW YORK, NY, 10017, US

(21) Appl. No.: 12/803,548

(22) Filed: Jun. 29, 2010

(30) Foreign Application Priority Data
Jun. 29, 2009 (DE) 10 2009 027 270.4

(51) Int. Cl. A62C 3/00

(52) U.S. Cl. 169/54

(57) ABSTRACT

A fire protection device for mounting in a preliminary formed opening (12) in a constructional component (11) and for leading a conduit (16) therethrough includes a housing (22; 52) having a through-opening (23; 53) for the conduit (16), and a fireproof insert (31) provided in the through-opening (23), a first attachment device (35; 58) provided on the housing (22; 52) in a region of a first end (25) of the housing for securing the fire protection device (21; 51) in the constructional component (11), and a second attachment device (40; 60) provided in a region of the second end (26; 56) and having at least one attachment section displaceable between its insertion and attachment positions in which the fire protection device, respectively, is insertable in the opening in the constructional component and is fixed therein.

### BACKGROUND OF THE INVENTION

1. Field of the Invention

The present invention relates to a fire protection device for mounting in a preliminary formed opening in a constructional component and for leading a conduit through the constructional component, the fire protection device including a housing having a through-opening for the conduit, a first end, a second end located opposite the first end, and a fireproof insert provided in the through-opening, and further including a first attachment device provided on the housing in a region of the first end for securing the fire protection device in the constructional component.

2. Description of the Prior Art

In order to fireproof leadthroughs in a constructional component such as, e.g., a wall or a ceiling of a building, so that in case of fire, no fire or smoke would spread from one room to another room, U.S. Pat. No. 6,694,684 discloses a fire protection device cast directly in a constructional component.

However, often, constructional parts are produced before a definite leadthrough is known or conduits between two adjacent rooms are subsequently provided. For passing a conduit through an already produced constructional part or component, a through-opening is formed in corresponding location in the constructional component with e.g., a drilling tool with a drill bit as a working tool. For mounting the fireproof means for a passed-through conduit and for adjustment of the leadthrough, the openings in the constructional components often have a diameter greater than the total diameter of the passing conduit or conduits.

German Utility Model DE 90 11 951 U discloses a fire protection device mountable subsequently in a preliminary formed opening in a constructional component for passing a conduit through the constructional component. The know fire protection device has a housing having a through-opening for the conduit, a first end, a second end located opposite the first end, and a fireproof insert provided in the through-opening.

In the region of the first end of the housing, there is provided a radially outwardly projecting flange that forms a first attachment device provided on the housing. In the flange there are provided openings for fastening elements which secure the fire protection device to the constructional component. In case of fire, the fireproof insert expands under action of heat and closes the hollow space and, in case of a melting pipe, the pipe cross-section against fire and smoke.

The drawback of the known device consists in that the outer dimensions of the housing must be adapted to the inner dimensions of the opening in the constructional component in order, e.g., to prevent tilting of the fire protection device in the opening upon passing of a conduit through. Therefore, the user should have available to him/her fire protection devices for each conventional diameter of the opening or for the working tool diameter. This requires large logistic expenses by both the manufacturer and the user.

Accordingly, an object of the invention is to provide a fire protection device in which the above-mentioned drawback of the known device is eliminated and, in particular, the costs of installation of the fire protection device are reduced.

Another object of the present invention is to provide a fire protection device which would insure a reliable attachment of the fire protection device to the constructional component.

### SUMMARY OF THE INVENTION

These and other objects of the present invention, which will become apparent hereinafter, are achieved by providing on the housing, in the region of the second end, a second attachment device having at least one attachment section displaceable from its insertion position that provides for insertion of the fire protection device in the opening of the constructional component, into its attachment position for securing the fire protection device in the constructional component.

In the insertion position of the second attachment device, the fire protection device can be easily inserted into the opening, e.g., by being pushed. When the second attachment device is displaced in its attachment position, e.g., by tightening the first attachment device, the fire protection device is easily secured in the constructional component. In one operational step or mounting step, the necessary fire proofing for the leadthrough is provided. The inventive fire protection device, contrary to the device according to DE 90 11 954 U, is secured in the constructional component at two, axially spaced from each other, regions.

Advantageously, the at least one attachment section of the second attachment device is so formed that the displacement from the insertion position in the attachment position takes place automatically. Alternatively, the displacement of the at least one attachment section from the insertion position in the attachment position is effected by actuation of actuation means that either already forms part of the fire protection device, e.g., by actuation of the first attachment device, or that is formed by separate, provided on the housing, actuation means.

When the fire protection device has a sealing element provided on the housing in the region of the first end and/or in the region of the second end, e.g., an annular, preferably elastic element, then, in the mounted condition of the fire protection device, not only fire protection is provided but also smoke tightness is provided, as well as improved proofing of the leadthrough against penetration of water. Still further, inspection by a third party of the fire protection device in its mounted condition is simplified as no additional elements, non-visible in the mounted condition of the fire protection device, are necessary for a reliable fireproofing of the leadthrough. Thus, the inventive fire protection device can be easily handled because with acquired operational skills, it can be mounted easily and error-free.

Advantageously, an elastic sealing element, e.g., a sealing diaphragm, that at least partially closes the through-opening, is provided on the housing. The sealing diaphragm is pierced or at least widened by the insertable conduit and advantageously sealingly engages the outer diameter of the passing through conduit. Such sealing element additionally seals the leadthrough against cold flue gases.

Advantageously, upon actuation of the first attachment device, the second attachment device can be displaced relative to the first attachment device along the longitudinal axis of the housing, so that upon tightening of the first attachment device, the second attachment device is displaced in the direction of the first attachment device. The attachment of the fire protection device is caused by reduction of the axial distance between the first and second attachment device, which insures an easy fixation of the fire protection device. Upon actuation of the first attachment device, the second attachment device is displaced from its insertion position into its attachment position, which further improves handling of the inventive fire protection device.

Advantageously, the first attachment device has an outer thread provided at the first end of the housing and a flange engageable with the outer thread. Thereby, the first attachment device is easily tightened. For tightening, the flange is screwed in the direction of a corresponding side of the constructional component until it abuts the constructional component. With a further screwing process, the second attachment device is displaced in an advantageous manner in the direction of the first attachment device, whereby the fire protection device is secured in the constructional component.

The flange has advantageously an annular abutting surface the outer diameter of which is greater than the largest inner diameter of the constructional component opening. Thereby, in the secured condition of the fire protection device, the flange completely covers the opening, tightly closing the same.

The tightness on the flange side of the constructional component can be further improved by providing an additional sealing element such as, e.g., an elastic element, e.g., an O-ring between the flange and the corresponding side of the constructional component.

Alternatively, the flange can be arranged in the region of the first end of the housing by using a bayonet-like connection.

According to an alternative embodiment, the first attachment device can be formed as a hoisting device that can be brought in abutment with an adjacent side of the constructional component and which upon tightening, is supported in an advantageous manner on the corresponding side of the constructional component, causing displacement of the second attachment device in direction of the first attachment device. E.g., the hoisting device can be formed as a corresponding eccentric level.

In a further alternative embodiment of the fire protection device, barbs are provided on the flange and/or in the region of the fist end of the housing. The barbs enable displacement of the flange in the direction of the second end of the housing, preventing, however, displacement of the flange in the direction of the first end of the housing.

The common feature of all of the above-described embodiments, which do not exhaust all possible constructions of the first attachment device, consists in that they provide for reduction of the axial distance between the first and second attachment devices, enabling an easy securing of the fire protection device.

Preferably, the at least one attachment section of the second attachment device engages from behind an edge of the opening in the constructional component. Thereby, the fire protection device is easily and reliably mounted in the constructional component. Advantageously, both edges of the opening in the constructional component on both opposite sides of the constructional component are engaged by the first attachment device and/or the second attachment device, respectively, in the mounted and tightened condition of the fire protection device.

Advantageously, the at least one attachment section of the second attachment device cooperates with a spring element connected with the housing and which is deformed upon insertion of the fire protection device in the opening in the constructional component and which returns, upon the fire protection device being fixed in the opening in the constructional component, in an initial position thereof that advantageously substantially corresponds to the attachment position of the at least one attachment section. The spring element is, e.g., formed of stamped and shaped spring steel and is secured formlockingly, e.g., by spot welding, to the housing. Alternatively, the spring element forms a part of the housing and is formed together with the housing, whereby an easily produced one-pieced part is obtained.

According to a further embodiment of the present invention, the at least one attachment section of the second attachment device is secured on the housing in a hinge-like manner. Thereby, the at least one attachment section can be displaced from its insertion position into its attachment position and, if necessary, from the attachment position into the insertion position by being pivoted or folded and unfolded. In this connection, under hinge-like manner is here understood at least a two-part arrangement in which one part is pivoted relative to the other part by an articulated element, e.g., a drag hinge.

On the fire protection device, there can be provided a plurality of differently formed attachment sections which together form the second attachment device. Further, there can be provided, in the region of the second end of the housing, a plurality of identical or differently formed attachment sections axially offset relative to each other with respect to the longitudinal axis of the housing as well as, advantageously, radially offset relative to each other. E.g., one portion of the attachment sections can engage an end region of the opening in the constructional component, and another portion of the attachment sections can be hooked in the wall of the opening.

Advantageously, the at least one attachment section of the second attachment device is spring-biased, whereby the at least one attachment section occupies, in its basic position, advantageously, its attachment position, and is displaced into its insertion position against a biasing force. Advantageously, a spring element for applying the biasing force is arranged between the outer surface of the housing and the at least one attachment section.

Advantageously, a free end of the at least one attachment section faces in direction of the first attachment device in an insertion position of the second attachment device. Thereby, in particular, upon an axial displacement of the second attachment device in the direction of the first attachment device, hooking of the free ends of the at least one attachment section, e.g., in the wall of the opening in the constructional component, or engagement of an end of the opening is insured in a simple manner.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiments, when read with reference to the accompanying drawings.

### BRIEF DESCRIPTION OF THE DRAWINGS:

The drawings show:

FIG. 1 a cross-sectional view illustrating insertion of an inventive fire protection device according to the first embodiment in an opening in a constructional component;

FIG. 2 a cross-sectional view of the device shown in FIG. 1 in its fixed position in the constructional component;

FIG. 3 a perspective view of a second embodiment of a fire protection device according to the present invention;

FIG. 4 a detail of a cross-sectional view of an attachment section of the second attachment device of the fire protection device shown in FIG. 3 in the attachment position thereof; and

FIG. 5 . a detail of a cross-sectional view of an attachment section of the second attachment device of the fire protection device shown in FIG. 3 in the insertion position thereof.

In the drawings, the same elements are designated with the same reference numerals.

### DETAILED DESCRIPTION OF THE PREFERRED EMBODIMENTS

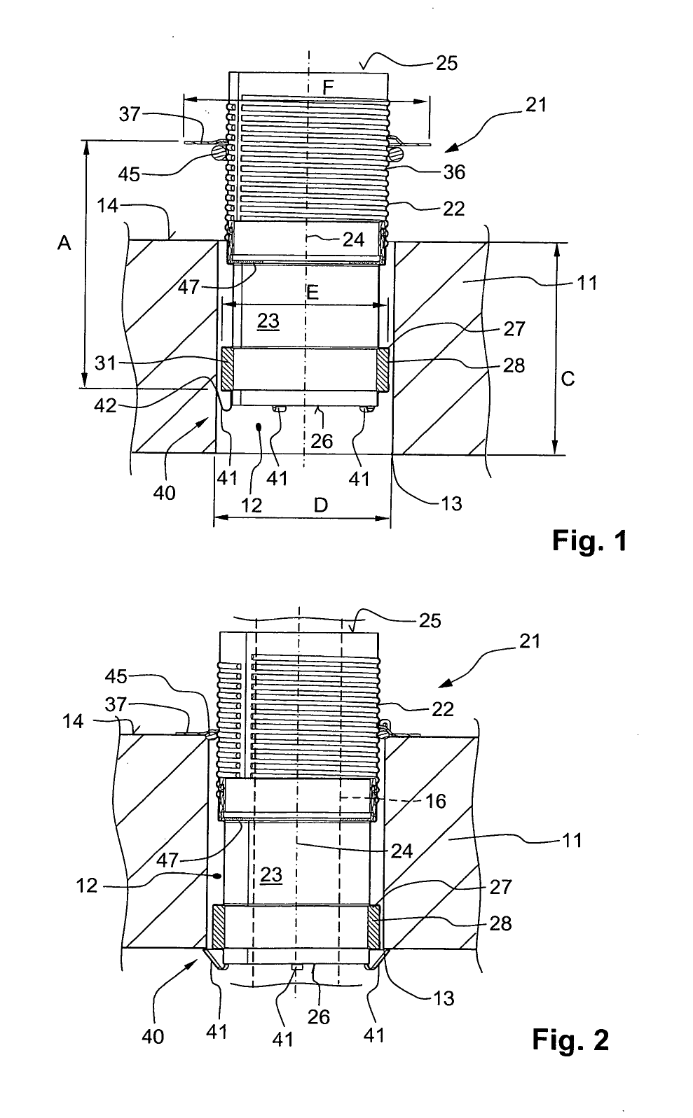

A fire protection device 21, which is shown in FIGS. 1-2, will subsequently be arranged in a preliminary formed opening 12 in a constructional component 11 and serves for passing as well as for fireproofing of a conduit 16 through the constructional component 11.

The fire protection device 21 has a cylindrical housing 22 extending along a longitudinal axis 24 and having a through-opening 23 for the conduit 16, a first end 25, and an opposite end 26. The housing 22 further has a receiving chamber 27 opening toward the through-opening 23 in which a fireproof insert 31 of intumescent material is provided.

The outer wall of the receiving chamber 27 is provided with openings 28 the function of which will be described further below. The maximal outer diameter E of the housing 22 is smaller than the inner diameter D of the opening 12 in the constructional component 11.

The housing 22 is provided with an outer thread 36 in the region of its first end 25. There is further provided a flange 37 engageable with the outer thread 36 and having an outer diameter F greater than the inner diameter D of the opening 12 in the constructional component 11. The outer thread 36 forms, together with the flange 37, a first attachment device 35 of the fire protection device 21.

At the second end 26 of the housing 22, there are provided a plurality of spring elements uniformly circumferentially distributed on the outer surface of the housing 22 and forming the attachment sections 41 of the second attachment deice 40 provided on the housing 22. The attachment device 40 is mounted after the fire protection device 21 is mounted in the opening 12 of the constructional component 11 for securing the fire protection device 21 on the constructional component 11 in its attachment position.

The spring elements of the attachment device 40 are formed of a spring steel and are secured in a material-locking manner on the outer side of the housing 22 by spot-welding. The free ends 42 of the attachment sections 41 face toward the first attachment device 30 in the mounted position of the second attachment device 40.

In the unloaded condition, the generatrix that surrounds the free ends 42 of the attachment sections 41, has an outer diameter greater then the inner diameter D of the opening 12 in the constructional component 11.

Below, the mounting process for arranging and attaching the fire protection device 21 will be described.

For mounting the fire protection device 21, the distance A between the free ends 42 of the attachment sections 41 and the flange 37 is so selected that it is greater than the thickness C of the constructional component 11. The fire protection device 21 is inserted in the opening 12 of the constructional component with the second end 26 first, with the attachment sections 41 being bent by the wall of the opening 12 in the direction of the outer side of the housing 22. As soon as the free ends 42 of the attachment sections 41 pass the opening 22 and are located outside of the opening 22, they expand to their initial dimension, so that the attachment sections 41 engage from behind the edge region 13 of the opening 12 in the constructional component 11.

Finally, the flange 37 is screwed in the direction of the side 14 of the constructional component 11 which is located opposite the edge region 13 of the opening 12. When the flange 37 abuts the component side 14, upon further screwing movement of the flange 37, the second attachment device 40 is displaced relative to the first attachment device 30 along the longitudinal axis 24 of the housing 22 until the attachment sections 41 of the second attachment device 40 are in their attachment position in which the edge region 13 of the opening 12 is engaged from behind it, a plurality of points. By reducing the distance between the first attachment device 30 and the second attachment device 40, the fire protection device 21 is reliably secured in the constructional component 11.

On the lower side of the flange 37 facing toward the second attachment device 40 there is provide an elastic O-ring forming a sealing element 45. In a loaded condition of the fire protection device 21, the sealing element 45 is clamped between the flange 37 and the side 14 of the constructional component 11 and seals the leadthrough, in the mounted condition of the fire protection device 21, additionally against penetration of water.

Further, n the housing 22, there is provided an elastic sealing element in form of a sealing diaphragm 47 that partially closes the through-opening 23. The sealing diaphragm 47 is widened by the insertable conduit 16 and sealingly engages the outer diameter of the inserted conduit 16.

In case of fire, the fireproof insert 31 expands in the direction of the conduit 16, completely and tightly engaging the melting pipe, as can be the case, and on the other hand, penetrates through the openings 28 in the outer wall of the receiving chamber 27, whereby any gap between the wall of the opening 12 and the fire protection device 21 is closed.

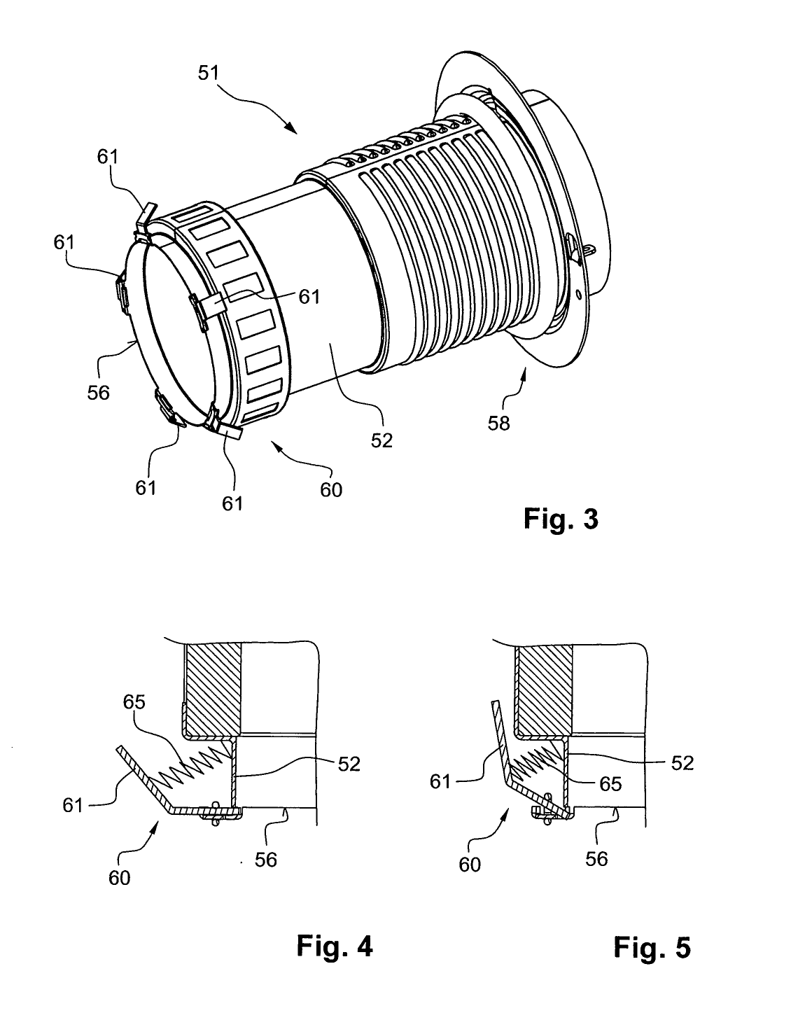

The fire protection device 51, which is shown in FIGS. 3-5, differs from the above-described fire protection device 21 by the design of the second attachment device 60 in the region of the second end 56 of the housing 52. In this embodiment, the second attachment device 60 has five attachment sections 61.

The attachment sections 61 are secured on the housing 52 in a hinge-like manner and are pivoted from their insertion position that provides for insertion of the fire protection device 51 in the opening 12 of the constructional component 11, into an attachment position for securing the fire protection device 51 in the constructional component 11. Between each attachment section 61 of the second attachment device 60 and the outer side of the housing 52, there is provided a compression helical spring forming a spring element 65 that biases the respective attachment section 51 in the direction of the insertion position.

Though the present invention was shown and described with references to the preferred embodiments, such are merely illustrative of the present invention and are not to be construed as a limitation thereof and various modifications of the present invention will be apparent to those skilled in the art. It is, therefore, not intended that the present invention be limited to the disclosed embodiments or details thereof, and the present invention includes all variations and/or alternative embodiments within the spirit and scope of the present invention as defined by the appended claims.

What is claimed is:

1. A fire protection device for mounting in a preliminary formed opening (12) in a constructional component (11) and for leading a conduit (16) through the constructional component (11), the fire protection device (21; 51) comprising a housing (22; 52) having a through-opening (23; 53) for the conduit (16), a first end (25), a second end (26, 56) located opposite the first end (25), and a fireproof insert (31) provided in the through-opening (23); a first attachment device (35; 58) provided on the housing (22; 52) in a region of the first end (25) for securing the fire protection device (21; 51) in the constructional component (11); and a second attachment device (40; 60) provided on the housing (22; 52) in a region of the second end (26; 56) and having at least one attachment section (41; 61) displaceable from an insertion portion thereof that provides for insertion of the fire protection device (21; 51) in the opening (12) of the constructional component (11), into an attachment position thereof for securing the fire protection device (21; 51) in the constructional component (21).

2. A fire protection device according to claim 1, wherein the second attachment device (40; 60) is displaced relative to the first attachment device (35; 58) along a longitudinal axis (24) of the housing (22; 52) when the first attachment device is actuated.

3. A fire protection device according to claim 2, wherein the first attachment device (35; 58) has an outer thread (36) provided at the first end (25) of the housing (22; 52) and a flange (37) engageable with the outer thread (36).

4. A fire protection device according to claim 1, wherein the at least one attachment section (41) of the second attachment device (40) engages from behind an edge (13) of the opening (12) in the constructional component (11).

5. A fire protection device according to claim 1, wherein the at least one attachment section (41) of the second attachment device (40) comprises a spring element connectable with the housing (22).

6. A fire protection device according to claim 1, wherein the at least one attachment section (61) of the second attachment deice (60) is secured on the housing in a hinge-like manner.

7. A fire protection device according to claim 6, wherein the at least one attachment section (61) of the second attachment device (60) is spring biased

8. A fire protection device according to claim 1, wherein a free end (42; 62) of the at least one attachment section (41; 61) faces in direction of the first attachment device (35, 58) in an insertion position of the second attachment device (40; 60).
